(19) United States
(12) Patent Application Publication
(10) Pub. No.: US 2015/0177865 A1
(43) Pub. Date: Jun. 25, 2015

(54) ALTERNATIVE INPUT DEVICE FOR PRESS/RELEASE SIMULATIONS

(71) Applicant: Sony Corporation, Tokyo (JP)

(72) Inventors: Alexandar Rodzevski, Lund (SE); Marcus Numminen, Lund (SE)

(73) Assignee: Sony Corporation, Tokyo (JP)

(21) Appl. No.: 14/133,681

(22) Filed: Dec. 19, 2013

(51) Int. Cl. G06F 3/042

(52) U.S. Cl. CPC G06F 3/042

(57) ABSTRACT

A device and method in accordance with the present disclosure provide alternate inputs to an electronic device having at least one of an optical sensor or a proximity sensor. An object is placed relative to at least one of the at least one proximity sensor or optical sensor, and the object is detected as an input to the electronic device based on an amount of light detected by the optical sensor or a proximity of the object relative to the electronic device as determined by the proximity sensor. The detected input is equated to a predetermined function of the electronic device.

### TECHNICAL FIELD OF THE INVENTION

The technology of the present disclosure relates generally to electronic devices and, more particularly, to an apparatus and method for providing alternative inputs to an electronic device.

### BACKGROUND

Electronic devices, such as mobile phones, cameras, music players, notepads, etc., are becoming increasingly popular. For example, mobile telephones, in addition to providing a means for communicating with others, provide a number of other features, such as text messaging, email, camera functions, the ability to execute applications, etc.

A popular feature of electronic devices, such as mobile telephones, is their ability to take photographs. With the ever advancing quality of photographic images produced by portable electronic devices, users no longer need to carry a separate “dedicated” camera to capture special moments.

To capture an image using an electronic device, a user simply points the electronic device at the object to be photographed and presses a button (e.g., a shutter button), which instructs the electronic device to capture the image. Initially, shutter buttons were implemented in electronic devices as mechanical buttons, e.g., a button that is physically displaced. With the advent of touch screens, many electronic devices implement so called “soft” shutter buttons, which map a touch zone on the display to a shutter button function.

For example, FIG. 1 illustrates a conventional electronic device in the form of a mobile telephone 10, the mobile telephone being in camera mode. To capture an image, a user points the mobile telephone at an object 12, and then touches a soft shutter button 14 on a display 16 of the electronic device 10. Upon touching the soft shutter button 14, the mobile telephone 10 stores an image obtained via camera optics (not shown) in memory of the phone.

### SUMMARY

Many manufacturers of portable electronic devices offer water proof models, and the popularity of such water proof models is increasing. Surprisingly, only a few models actually have a mechanical shutter button. The lack of a mechanical shutter button can make the underwater picture taking process a bit tricky, since touch screens typically do not work underwater.

One approach to overcoming the above limitation is to capture an image at certain time intervals. A problem with this approach, however, is that one may desire to capture a specific moment in time, and the “interval” on the electronic device may not correspond to that specific moment in time.

In accordance with the present disclosure a means is provided for user interface operations on an electronic device in situations where a touch screen is inoperative, e.g., when the electronic device is underwater, wet, or broken, or simply when an alternative input means to the touch screen is desired.

According to one aspect of the invention, a press and/or release event, such as a camera shutter button function or other function that can be implemented with a press and/or release event, can be realized using an optical device (e.g., a light sensor, a camera, etc.) and/or proximity sensor of the electronic device.

According to one aspect of the invention, a method of controlling an electronic device that includes at least one of an optical sensor or a proximity sensor is provided. The method includes: placing an object relative to at least one of the at least one proximity sensor or optical sensor; detecting as an input to the electronic device the object based on an amount of light detected by the optical sensor or a proximity of the object relative to the electronic device as determined by the proximity sensor; and equating the detected input to a predetermined function of the electronic device.

According to one aspect of the invention, the method includes performing at least one of the placing, detecting or equating steps while the electronic device is underwater.

According to one aspect of the invention, the method includes determining the electronic device is underwater based on signal deviation in the raw touch data from a touch input device of the electronic device.

According to one aspect of the invention, the method includes using a humidity sensor to determine when the electronic device is underwater.

According to one aspect of the invention, the predetermined function corresponds to a press and/or release event.

According to one aspect of the invention, the predetermined function is a camera shutter button function.

According to one aspect of the invention, placing the object includes swiping the object over the proximity sensor or over the optical sensor.

According to one aspect of the invention, swiping the object comprises blocking light from impinging on the optical sensor or the proximity sensor.

According to one aspect of the invention, the optical sensor comprises a photographic camera or a light sensor for detecting a level of ambient light.

According to one aspect of the invention, the method includes arranging a light source relative to the optical sensor to provide a minimum level of light to the optical sensor when the optical sensor is in an unblocked state.

According to one aspect of the invention, the method includes comprising using an electronic device that includes a display device.

According to one aspect of the invention, the method includes a portable electronic device includes: at least one of an optical sensor operative to detect an amount of ambient light or a proximity sensor operative to detect a distance of an object relative to the proximity sensor; a processor and memory; and logic stored in said memory and executable by the processor, said logic including logic that detects an alternate input mode of the electronic device; logic that detects as an input to the electronic device the object based on an amount of light detected by the optical sensor or a distance of the object detected by the proximity sensor proximity sensor; and logic that when in the alternate input mode equates the detected input to a predetermined function of the electronic device.

According to one aspect of the invention, the device includes comprising a humidity sensor operative to determine when the electronic device is underwater, wherein the logic that detects the alternate input mode bases the detection on an output of the humidity sensor.

According to one aspect of the invention, the device includes a touch screen input device arranged on a first side of the portable electronic device.

According to one aspect of the invention, the logic that determines the electronic device is in the alternate input mode bases the determination on signal deviation in the raw touch data from the touch screen input device.

According to one aspect of the invention, the optical sensor is arranged on the first side.

According to one aspect of the invention, the device includes the predetermined function corresponds to a press and/or release event.

According to one aspect of the invention, the predetermined function is a camera shutter button function.

According to one aspect of the invention, the logic that detects placement includes logic that equates swiping the object over the proximity sensor or the optical sensor as an input command.

According to one aspect of the invention, the logic that equates swiping includes logic that equates blocking light from impinging on the optical sensor as an input command.

According to one aspect of the invention, the device includes a light source arranged relative to the optical sensor to provide a minimum level of light to the optical sensor when the optical sensor is in an unblocked state.

According to one aspect of the invention, the logic that equates the detected input to a predetermined function includes logic that stores image data in memory of the electronic device as a photographic image.

According to one aspect of the invention, the optical sensor comprises a photographic camera or a light sensor for detecting a level of ambient light.

To the accomplishment of the foregoing and the related ends, the device and method comprises the features hereinafter fully described in the specification and particularly pointed out in the claims, the following description and the annexed drawings setting forth in detail certain illustrative embodiments, these being indicative, however, of but several of the various ways in which the principles of the invention may be suitably employed.

Although the various features are described and are illustrated in respective drawings/embodiments, it will be appreciated that features of a given drawing or embodiment may be used in one or more other drawings or embodiments of the invention.

### BRIEF DESCRIPTION OF THE DRAWINGS

FIG. 1 is a schematic view of an electronic device in the form of a mobile telephone in use during camera mode.

FIG. 2 is a schematic block diagram of modules of an electronic device that utilizes alternate input means for controlling functions of the electronic device.

FIGS. 3A and 3B are schematic views of a front and back side, respectively, of an exemplary electronic device.

FIG. 4 is a schematic view illustrating entry of an input command in accordance with an embodiment of the disclosure.

FIG. 5 is a block diagram of an exemplary sensor unit of an electronic device.

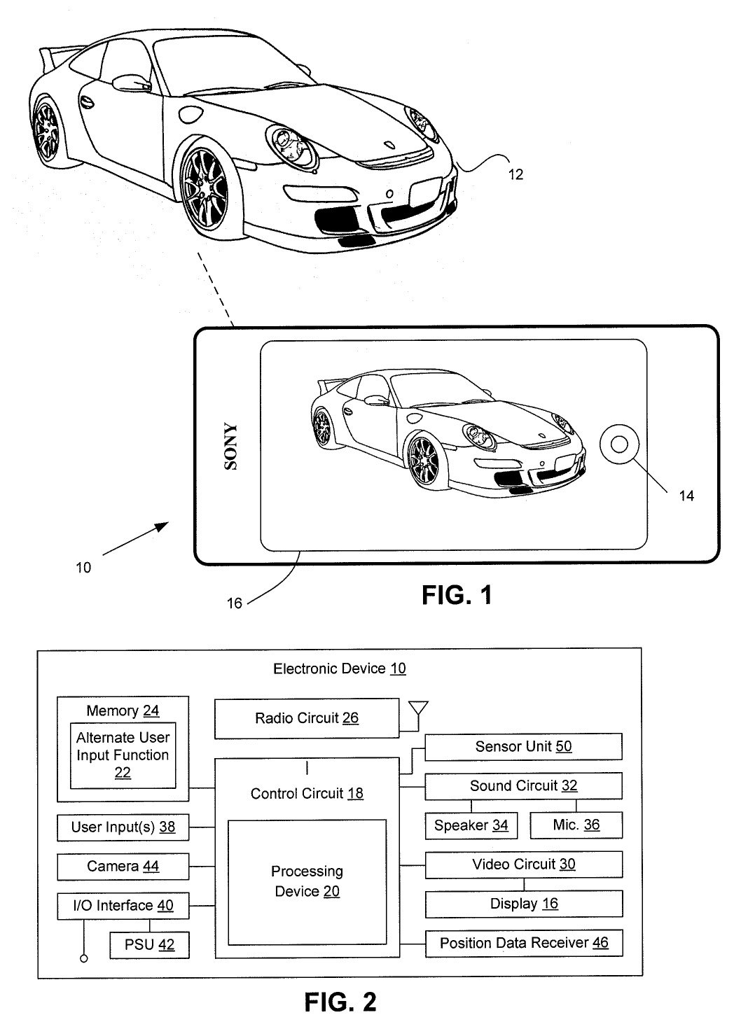

### DETAILED DESCRIPTION OF EMBODIMENTS

Embodiments will now be described with reference to the drawings, wherein like reference numerals are used to refer to like elements throughout. It will be understood that the figures are not necessarily to scale. Features that are described and/or illustrated with respect to one embodiment may be used in the same way or in a similar way in one or more other embodiments and/or in combination with or instead of the features of the other embodiments.

Described below in conjunction with the appended figures are various embodiments of an apparatus and a method for providing inputs to an electronic device when a conventional means for providing inputs is inoperative, e.g., a touch screen is inoperative when the electronic device is underwater, or when an alternate input means is desired. While embodiments in accordance with the present disclosure relate, in general, to the field of electronic devices, for the sake of clarity and simplicity most embodiments outlined in this specification are described in the context of mobile phones. It should be appreciated, however, that features described in the context of mobile phones are also applicable to other electronic devices.

Electronic devices, such as mobile phones, generally include a light sensor for detecting an amount of ambient light. Based on the detected ambient light, the electronic device, for example, may vary a brightness of a display. Similarly, electronic devices also typically include a proximity sensor for detecting when an object is near/far of a surface of the electronic device. If the proximity sensor detects that an object is in close proximity to the electronic device, certain actions may be taken, e.g., ringer volume may be decreased, the display may be turned off to conserve battery power, the touch panel may be distabled to prevent unwanted touch events, etc.

In accordance with one embodiment provided in the present disclosure, a light sensor and/or proximity sensor of the electronic device is/are used to provide an input command, e.g., a press and/or release event. For example, placement of an object, such as a user's finger, over the light sensor can be interpreted as a press and/or release event such as a request to capture an image from the electronic device's camera, e.g., a shutter button function. Similarly, placement of the object, such as the user's finger, within a predetermined distance of the proximity sensor also can be interpreted as a press and/or release event. Further details regarding the inventive features will be discussed in more detail below.

Referring to FIG. 2, schematically shown is an exemplary electronic device in the form of a mobile phone 10 in accordance with the present disclosure. The electronic device 10 includes a control circuit 18 that is responsible for overall operation of the electronic device 10. For this purpose, the control circuit 18 includes a processor 20 that executes various applications, such as an alternate user input function 22 that carries out tasks that enable robust user input to the electronic device when the electronic device's touch screen is inoperative as described in greater detail below. As indicated, the alternate user input function 22 may be implemented in the form of logical instructions that are executed by the processor 20.

The processor 20 of the control circuit 18 may be a central processing unit (CPU), microcontroller or microprocessor. The processor 20 executes code stored in a memory (not shown) within the control circuit 18 and/or in a separate memory, such as a memory 24, in order to carry out operation of the electronic device 10. The memory 24 may be, for example, one or more of a buffer, a flash memory, a hard drive, a removable media, a volatile memory, a non-volatile memory, a random access memory (RAM), or other suitable device. In a typical arrangement, the memory 24 includes a non-volatile memory for long term data storage and a volatile memory that functions as system memory for the control circuit 18. The memory 24 may exchange data with the control circuit 18 over a data bus. Accompanying control lines and an address bus between the memory 24 and the control circuit 18 also may be present. The memory 24 is considered a non-transitory computer readable medium.

The electronic device 10 may include communications circuitry that enables the electronic device 10 to establish various wireless communication connections. In the exemplary embodiment, the communications circuitry includes a radio circuit 26. The radio circuit 26 includes one or more radio frequency transceivers and an antenna assembly (or assemblies). The electronic device 10 may be capable of communicating using more than one standard. Therefore, the radio circuit 26 represents each radio transceiver and antenna needed for the various supported connection types. The radio circuit 26 further represents any radio transceivers and antennas used for local wireless communications directly with an electronic device, such as over a Bluetooth interface.

The electronic device 10 is configured to engage in wireless communications using the radio circuit 26, such as voice calls, data transfers, and the like. Data transfers may include, but are not limited to, receiving streaming content, receiving data feeds, downloading and/or uploading data (including Internet content), receiving or sending messages (e.g., chat-style messages, electronic mail messages, multimedia messages), and so forth.

Wireless communications may be handled through a subscriber network, which is typically a network deployed by a service provider with which the user of the electronic device 10 subscribes for phone and/or data service. Communications between the electronic device 10 and the subscriber network may take place over a cellular circuit-switched network connection. Exemplary interfaces for cellular circuit-switched network connections include, but are not limited to, global system for mobile communications (GSM), code division multiple access (CDMA), wideband CDMA (WCDMA), and advanced versions of these standards. Communications between the electronic device 10 and the subscriber network also may take place over a cellular packet-switched network connection that supports IP data communications. Exemplary interfaces for cellular packet-switched network connections include, but are not limited to, general packet radio service (GPRS) and 4G long-term evolution (LTE).

The cellular circuit-switched network connection and the cellular packet-switched network connection between the electronic device 10 and the subscriber network may be established by way of a transmission medium (not specifically illustrated) of the subscriber network. The transmission medium may be any appropriate device or assembly, but is typically an arrangement of communications base stations (e.g., cellular service towers, also referred to as “cell” towers). The subscriber network includes one or more servers for managing calls placed by and destined to the electronic device 10, transmitting data to and receiving data from the electronic device 10, and carrying out any other support functions. As will be appreciated, the server may be configured as a typical computer system used to carry out server functions and may include a processor configured to execute software containing logical instructions that embody the functions of the server and a memory to store such software and related data.

Another way for the electronic device 10 to access the Internet and conduct other wireless communications is by using a packet-switched data connection apart from the subscriber network. For example, the electronic device 10 may engage in IP communication by way of an IEEE 802.11 (commonly referred to as WiFi) access point (AP) that has connectivity to the Internet.

The electronic device 10 may further include a display 16 for displaying information to a user. The displayed information may include the second screen content. The display 16 may be coupled to the control circuit 18 by a video circuit 30 that converts video data to a video signal used to drive the display 16. The video circuit 30 may include any appropriate buffers, decoders, video data processors, and so forth.

The electronic device 10 may further include a sound circuit 32 for processing audio signals. Coupled to the sound circuit 32 are a speaker 34 and a microphone 36 that enable a user to listen and speak via the electronic device 10, and hear sounds generated in connection with other functions of the device 10. The sound circuit 32 may include any appropriate buffers, encoders, decoders, amplifiers and so forth.

The electronic device 10 also includes one or more user inputs 38 for receiving user input for controlling operation of the electronic device 10. Exemplary user inputs include, but are not limited to, a touch input that overlays the display 16 for touch screen functionality, one or more buttons, motion sensors (e.g., gyro sensors, accelerometers), and so forth.

The electronic device 10 may further include one or more input/output (I/O) interface(s) 40. The I/O interface(s) 40 may be in the form of typical electronic device I/O interfaces and may include one or more electrical connectors for operatively connecting the electronic device 10 to another device (e.g., a computer) or an accessory (e.g., a personal handsfree (PHF) device) via a cable. Further, operating power may be received over the I/O interface(s) 10 and power to charge a battery of a power supply unit (PSU) 42 within the electronic device 10 may be received over the I/O interface(s) 40. The PSU 42 may supply power to operate the electronic device 10 in the absence of an external power source.

The electronic device 10 also may include various other components. For instance, a camera 44 may be present for taking digital pictures and/or movies. Image and/or video files corresponding to the pictures and/or movies may be stored in the memory 24. As another example, a position data receiver 46, such as a global positioning system (GPS) receiver, may be present to assist in determining the location of the electronic device 10. Yet another example is a sensor unit 50, which may include various sensors such as light sensors, proximity sensors, humidity sensors, etc., which can be used to control various parameters of the electronic device 10.

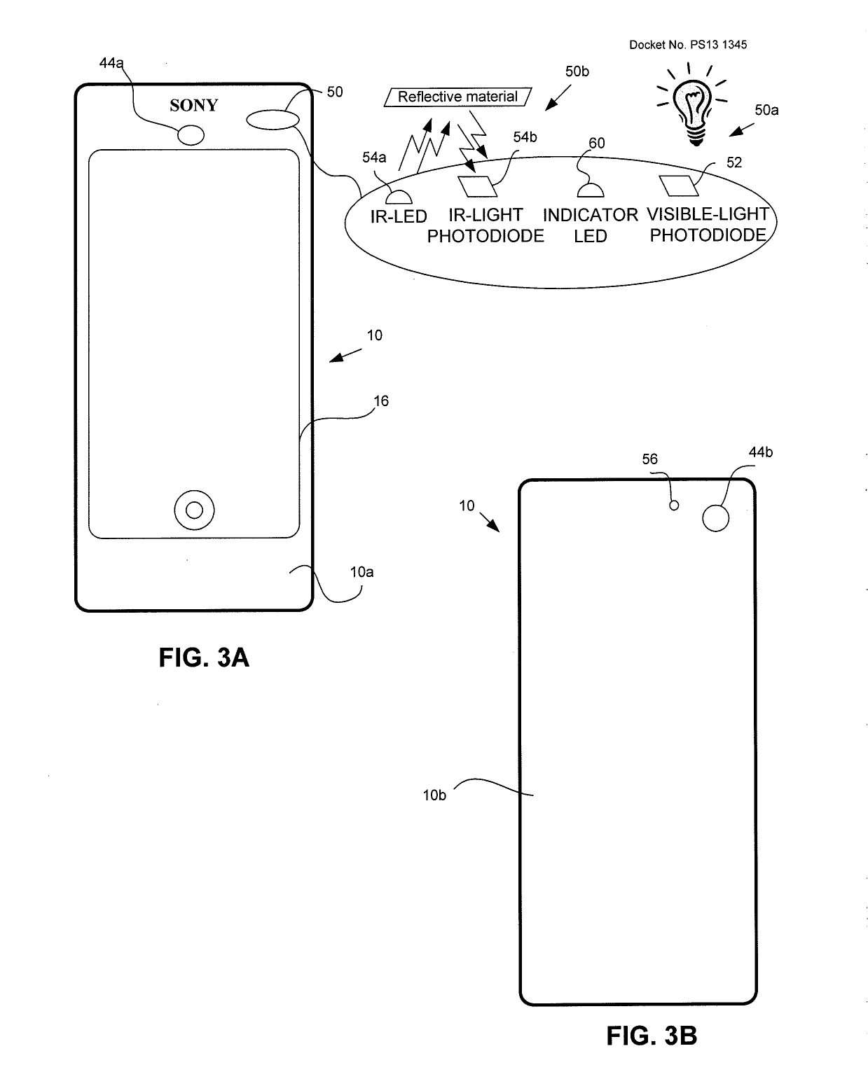

With additional reference to FIGS. 3A and 3B, front 10a and back sides 10b of an electronic device 10 in the form of a mobile telephone are shown. The front side 10a of the mobile telephone includes a display 16 and a first camera 44a. The first camera 44a may be a “chat” camera, which can be used, for example, in conjunction with a video telephone call. More specifically, the first camera 44a is arranged on the mobile telephone 10 so as to capture an image of the user as the user views the display 16, e.g., during a video call with another person. The images captured by the first camera 44a along with captured audio may be transmitted by the mobile telephone 10 to an electronic device used by the communicating party. Similarly, images and audio of the communicating party also may be captured and transmitted back to the user's mobile phone 10, the images being displayed on the display 16 and the audio being output via the speaker 34.

Mobile phones also typically include a sensor unit 50, which may include a light sensor 50a and proximity sensor 50b arranged on the front side 10a of the mobile phone 10. The light sensor 50a, which may include a visible light photodiode 52, is configured to detect ambient light and provide such information to the control circuit 18. Based on the detected light, the control circuit 18 may manipulate parameters of the mobile phone (e.g., screen brightness, enabling/disabling a camera flash, etc.).

The proximity sensor 50b, which may include an infrared LED 54a and an infrared photodiode 54b, is configured to detect a distance of an object relative to the front surface 10a of the mobile phone 10. For example, when an object is within a predetermined distance of the proximity sensor 50b, infrared light emitted by the infrared LED 54a is reflected off the object and back to the infrared photodiode 54b. The infrared photodiode 54b detects the reflected light, which is equated to the object being in close proximity to the sensor. Based on the detected distance, various parameters of the mobile phone may be adjusted, e.g., the ringer volume may be decreased, the display turned off, the touch inputs disabled, etc.

It should be noted that while the proximity sensor 50b is described using optical devices, proximity sensors based on technology other than optical devices are contemplated to fall within the scope of the present invention. For example, the proximity sensor 50a may employ one or more of capacitance, laser, sound or other techniques to determine the proximity of an object.

The back side 10b of the mobile phone 10 includes a second camera 44b, which typically is the primary photographic camera. In addition, a flash device 56 (e.g., an LED) also may be arranged on the back side 10b of the mobile phone 10, the flash device providing additional lighting for image capture in low-light conditions.

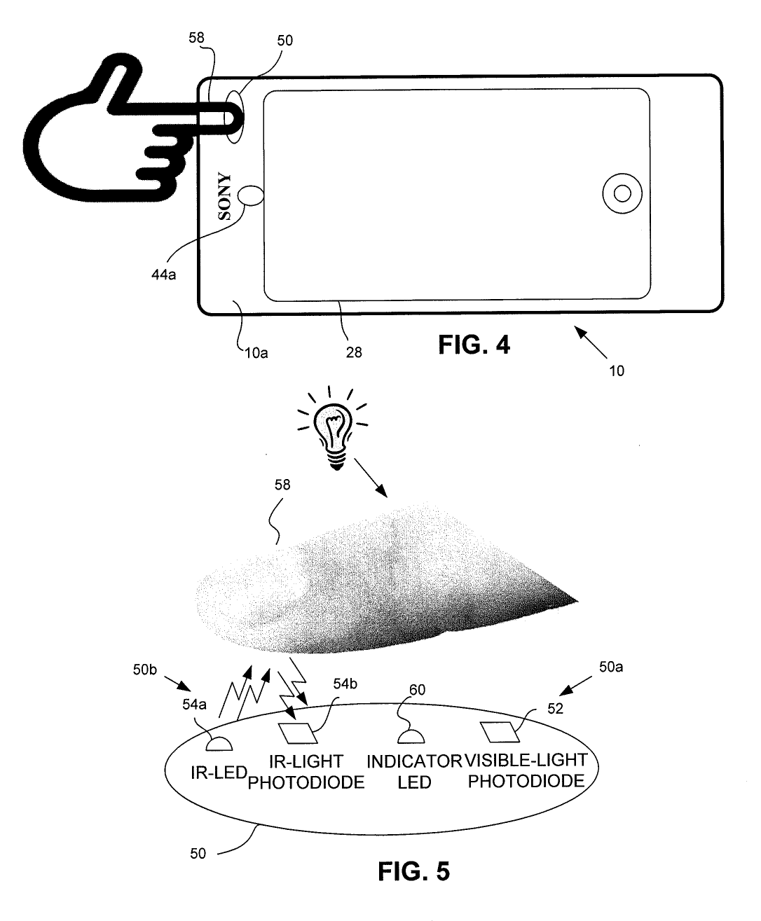

In accordance with one embodiment of the present disclosure, operation of an electronic device via alternate input means is implemented via at least one of an optical sensor, e.g., the light sensor 50a, and/or the proximity sensor 50b. More specifically, and with reference to FIGS. 4 and 5, inputs corresponding to one or both of the light sensor 50a and the proximity sensor 50b may be configured to perform a specific function, such as a camera function or other functions associated with a specific application. To activate the desired function, a user simply places an object, such as his finger 58, on or over the light sensor 50a and/or proximity sensor 50b.

The light sensor 50a may be a passive sensor that can be polled to read, for example, a linear scale of light saturation (0=completely dark, 255=full light) or LUX-values. Placement of the object over the light sensor 50a will result in a drastic decrease in the amount of detected light. By comparing the detected light level to a threshold light level (e.g., a threshold level that represents little or no detected light), it can be determined if a user is placing an object over the light sensor 50a. When such input is detected while the mobile phone 10 is in camera mode and/or the touch input device is inoperable, the input can be mapped, for example, to the camera shutter button function.

In one embodiment a camera of the electronic device (e.g., camera 44a) may be used to detect the ambient light, e.g., image data captured by the camera can be analyzed to determine an amount of light. For example, the image data can be compared to reference data to determine if an object is placed over the camera (a finger covering the camera may produce an orange-colored image, which can be equated to the camera being covered). Such information then can be identified as an input and mapped, for example, to a camera shutter function. The camera 44a and the light sensor 50a may be referred to generally as an optical sensor.

With respect to the proximity sensor 50b, such sensor can detect, for example, when IR light emitted from an IR diode 54a is reflected by an object (e.g., a finger 58) back to an IR-photodiode 54b. Thus, placement of the object 58 over or within a predetermined distance of the proximity sensor 50b will result in the proximity sensor 50b generating a signal corresponding to the presence of the object 58. When such input is detected while the mobile phone 10 is in a particular mode, e.g., camera mode, the input can be mapped, for example, to the camera shutter function.

To assist the user in locating the proximity sensor 50b and/or light sensor 50a while underwater, an indicator 60, such as a light emitting diode (LED) or the like, can be located adjacent to the respective sensors. When the mobile phone 10 is placed in specific mode and/or when an underwater condition is detected, the indicator 60 can be activated thereby optically indicating a location of the respective sensors 50a and 50b. Alternatively or additionally, the graphical display 16 of the mobile phone 10 could include an indicator, such as a pointer, that identifies an approximate location of the proximity sensor 50b and/or light sensor 50a. Alternatively or additionally, the graphical display 16 could provide an icon and/or textual description indicative of the function to which the respective sensors are mapped, e.g., an icon near the sensor 50 representing a camera shutter button, enter button, select button, etc., thereby signifying the function associated with the sensor.

Further, while either the proximity sensor 50b or the light sensor 50a may be used to individually invoke a command, it is preferable that a combination of the two sensors be used to invoke a command. Using both sensors provides for a more robust system, with less likelihood of false positives due to reflections in the water (proximity sensor) or very dark water (light sensor).

Further, the indicator 60 could be used to prevent false positive detections by the light sensor 50a. More specifically, the indicator 60 can be strategically placed such that it provides a defined light level for the light sensor 50a, even when no other light is available. Then, as an object is placed over the light sensor 50a, the change in light can be detected by the sensor 50a.

As noted above, the alternate input means would generally be used when the conventional entry means is disabled or otherwise inoperative (e.g., when the touch screen is inoperative due to the electronic device being underwater). Activation of an “underwater mode” can be implemented, for example, via a graphical user interface of the mobile telephone 10. For example, a “settings” interface may be accessible on the mobile phone via a “settings” icon or the like. Included within the settings interface may be a soft switch for specifying normal operation or underwater operation. Manipulating the soft switch to correspond to underwater operation can change how the phone interprets the light sensor 50a and/or proximity sensor 50b. Alternatively, the mobile phone 10 may automatically detect underwater operation and switch modes accordingly. For example, when a touch screen of the display 16 becomes wet, the touch screen may generate erratic signals. Such erratic signals can be interpreted as the mobile phone 10 being underwater and the phone can switch to underwater mode.

For example, the raw touch data may be analyzed, and inconsistent and/or un-even signal levels (stochastic) may be detected over the touch panel. Such inconsistent and/or un-even signal levels (referred to as signal distortion) data can provide a very distinct signal scenario, thus making a wet or underwater touch screen easy to detect. Detection of underwater operation preferably is handled, for example, by the touch panel firmware, and a notification may be sent to the host (e.g., Phones App-CPU).

Yet another option would be to include a humidity sensor in the phone 10, e.g., within the sensor unit 50. Then, based on the humidity as detected by the humidity sensor, it can be concluded that the phone 10 is or is not underwater. Regardless of how underwater mode is selected, once enabled the proximity sensor 50b and/or light sensor 50a become enabled as input devices.

In one embodiment, the control circuit 18 commands an image to be captured upon “blocking” light from the light sensor 50a.

In one embodiment, the control circuit 18 of the mobile phone 10 commands an image to be captured upon unblocking the light sensor 50a, e.g., a transition from substantially no light to light being detected by the light sensor 50a).

Although certain embodiments have been shown and described, it is understood that equivalents and modifications falling within the scope of the appended claims will occur to others who are skilled in the art upon the reading and understanding of this specification.

1. A method of controlling a electronic device that includes at least one of an optical sensor or a proximity sensor, the method comprising:
placing an object relative to at least one of the at least one proximity sensor or optical sensor;
detecting as an input to the electronic device the object based on an amount of light detected by the optical sensor or a proximity of the object relative to the electronic device as determined by the proximity sensor; and
equating the detected input to a predetermined function of the electronic device.

2. The method according to claim 1, further comprising performing at least one of the placing, detecting or equating steps while the electronic device is underwater.

3. The method according to claim 2, further comprising determining the electronic device is underwater based on signal deviation in the raw touch data from a touch input device of the electronic device.

4. The method according to claim 2, further comprising using a humidity sensor to determine when the electronic device is underwater.

5. The method according to claim 1, wherein the predetermined function corresponds to a press and/or release event.

6. The method according to claim 5, wherein the predetermined function is a camera shutter button function.

7. The method according to claim 1, wherein placing the object includes swiping the object over the proximity sensor or over the optical sensor.

8. The method according to claim 7, wherein swiping the object comprises blocking light from impinging on the optical sensor or the proximity sensor.

9. The method according to claim 1, wherein the optical sensor comprises a photographic camera or a light sensor for detecting a level of ambient light.

10. The method according to claim 1, further comprising arranging a light source relative to the optical sensor to provide a minimum level of light to the optical sensor when the optical sensor is in an unblocked state.

11. The method according to claim 1, further comprising using an electronic device that includes a display device.

12. A portable electronic device, comprising:
at least one of an optical sensor operative to detect an amount of ambient light or a proximity sensor operative to detect a distance of an object relative to the proximity sensor;
a processor and memory; and
logic stored in said memory and executable by the processor, said logic including
logic that detects an alternate input mode of the electronic device;
logic that detects as an input to the electronic device the object based on an amount of light detected by the optical sensor or a distance of the object detected by the proximity sensor proximity sensor; and
logic that when in the alternate input mode equates the detected input to a predetermined function of the electronic device.

13. The device according to claim 12, further comprising a humidity sensor operative to determine when the electronic device is underwater, wherein the logic that detects the alternate input mode bases the detection on an output of the humidity sensor.

14. The device according to claim 12, further comprising a touch screen input device arranged on a first side of the portable electronic device.

15. The device according to claim 14, wherein the logic that determines the electronic device is in the alternate input mode bases the determination on signal deviation in the raw touch data from the touch screen input device.

16. The device according to claim 14, wherein the optical sensor is arranged on the first side.

17. The device according to claim 12, wherein the predetermined function corresponds to a press and/or release event.

18. The device according to claim 17, wherein the predetermined function is a camera shutter button function.

19. The device according to claim 18, wherein logic that detects placement includes logic that equates swiping the object over the proximity sensor or the optical sensor as an input command.

20. The device according to claim 19, wherein the logic that equates swiping includes logic that equates blocking light from impinging on the optical sensor as an input command.

21. The device according to claim 12, further comprising a light source arranged relative to the optical sensor to provide a minimum level of light to the optical sensor when the optical sensor is in an unblocked state.

22. The device according to claim 12, wherein the logic that equates the detected input to a predetermined function includes logic that stores image data in memory of the electronic device as a photographic image.

23. The device according to claim 12, wherein the optical sensor comprises a photographic camera or a light sensor for detecting a level of ambient light.
